(19) United States
(12) Patent Application Publication
(10) Pub. No.: US 2022/0317866 A1
(43) Pub. Date: Oct. 6, 2022

(54) INLINE FRAME BASED VIDEO RENDERING WITHIN BROWSER

(71) Applicant: Loop Now Technologies, Inc., San Mateo, CA (US)

(72) Inventors: Stefan Backor, Zilina (SK); Wu-Hsi Li, Somerville, MA (US); Michal Svrcek, Zilina (SK)

(73) Assignees: Loop Now Technologies, Inc., San Mateo, CA (US); Loop Now Technologies, Inc., San Mateo, CA (US)

(21) Appl. No.: 17/711,090

(22) Filed: Apr. 1, 2022

Related U.S. Application Data
(60) Provisional application No. 63/302,593, filed on Jan. 25, 2022.
(60) Provisional application No. 63/226,081, filed on Jul. 27, 2021.
(60) Provisional application No. 63/196,252, filed on Jun. 3, 2021.
(60) Provisional application No. 63/169,973, filed on Apr. 2, 2021.

(51) Int. Cl. G06F 3/04845; G06F 3/0485

(52) U.S. Cl. CPC G06F 3/04845; G06F 3/0485; G06F 3/0483

(57) ABSTRACT

Techniques for display based on inline frame-based video rendering within browser are disclosed. A plurality of short-form videos is obtained. Thumbnails of one or more short-form videos, from the plurality of short-form videos, are displayed. The displaying thumbnails occurs within a frame on a third-party webpage within a browser window. A user's selection of a video from the short-form videos is received. The video that was selected by a user is reduced. The reducing the video enables the video to be rendered in a portion of the browser window. The reducing the video to render the video in a portion of the browser window includes launching a reloaded version of the third-party webpage to render the video superimposed over the third-party webpage. The video that was reduced is rendered, along with a reloaded copy of the third-party webpage, in the browser window.

### RELATED APPLICATIONS

This application claims the benefit of U.S. provisional patent applications “Inline Frame Based Video Rendering Within Browser” Ser. No. 63/169,973, filed Apr. 2, 2021, “Frame And Child Frame For Video And Webpage Rendering” Ser. No. 63/196,252, filed Jun. 3, 2021, “Video Stream Interface Based On Third-Party Webpage Information” Ser. No. 63/226,081, filed Jul. 27, 2021, and “Ecommerce Purchase Within A Short-Form Video Environment” Ser. No. 63/302,593, filed Jan. 25, 2022.

Each of the foregoing applications is hereby incorporated by reference in its entirety.

### FIELD OF ART

This application relates generally to display and more particularly to inline frame-based video rendering within a browser.

### BACKGROUND

Web surfing, the online activity where people spend inordinate amounts of productive, leisure, and procrastination time accessing the Internet, is a highly popular pastime. The information found by web surfing can inform, educate, entertain, amuse, engage, and for some web surfers, enrage, among many other reactions. The information typically includes text, still images, audio content, and video content. The information also includes links to further information, online assistance, and more. Some of the information is presented as an audio or video presentation. Although audio-only presentations can be informative and entertaining, many people prefer the more engaging and immersive experience that results when the presentations include both video and audio. The web surfing can indeed enable meaningful activities such as research, education, or work, but more often, it seems the web surfing is undertaken for personal communication, shopping, entertainment, gaming, looking for and watching videos of adorable children or pets, or just passing the time. The web surfing is accomplished using a wide range of electronic devices to engage with the online information and content found at various websites. The electronic devices, and particularly personal electronic devices, provide access to a seemingly endless supply of information.

To get to or “navigate” to a website, a person starts a web browser on their electronic device and navigates to a website. Navigating to the website begins by entering a web address called a uniform resource locator (URL). The navigation to the website can include typing or speaking the address, selecting an address resulting from a web search, or selecting a bookmarked site, among other techniques. Once entered, the URL directs the person to a homepage or landing page. The website homepage presents a variety of content to the person. Popular content includes news, sports, politics, adorable pet videos, products or services for sale, and much more. The person can click on stories, sports scores, conspiracy theories, or whatever content is of interest to them. From a user perspective, finding an interesting website starts either by navigating to a site familiar to the person or by using an Internet search engine. The person enters a search string into the search engine and initiates the search with a button click. The string of characters used for the search must be carefully crafted, or the user will be deluged with a surfeit of results. Some of the search results will be useful to the person, while many, many others will be irrelevant or simply useless. From a provider perspective, such as that of an online retailer, vendor, or service provider, success or failure of their business directly relies on presenting goods and services to prospective customers and then converting the prospective customers to buyers. The “right” webpage needs to be presented quickly and must rise to the top of the search results to the potential customer who is looking for a product or service. If such a presentation is not accomplished, then the customer will go elsewhere or will simply give up due to loss of interest or lack of time.

### SUMMARY

People use a wide variety of electronic devices to view and interact with media content of many types. The electronic devices used, such as desktop computers, laptop computers, tablets, smartphones, and PDA are highly popular and commonly available. These electronic devices are used by people who want to observe and interact with the media content. The media content, which is often rendered within web browsers as webpages, presents news, sports, government information, political media, entertainment, educational media, streaming media, and so on. Among the most popular content is social media content, where celebrities, individuals, influencers, tastemakers, and others with a message, a mission, or an opinion present their media wares to influence, inform, persuade, sell, or even misguide their followers. The web content typically includes text, photographs, videos including live-feed video, audio, and the like. An individual interacting with the webpage may choose to learn more about a news story, a sports team, a product or service, an opinion, etc. Seeking further information can include conducting a web search, which can result in hundreds, thousands, millions, or more search results or “hits”. The individual must then decide whether to investigate some of the search results, conduct further searches using different search tools or search strings, etc. If the search is timely and specific, such as a search that involves tracking a breaking news story or the latest indiscretion or dalliance of a celebrity, the small number and high relevance of the top search results can be easily managed, allowing the user to choose their preferred information source. Conversely, if the search is for a product or service, and particularly if the exact terminology for the search string is partially remembered or unknown, then the individual is presented with an overwhelming number of results of low relevance. Alternatively, the user can further interact with the webpage by selecting content presented to the user within a frame on a webpage such as a third-party webpage. The content within the frame can include photographs, links to stories, short-form videos, etc. that present further information about relevant topics of likely interest to the user.

Display is based on inline frame-based video-rendering within a browser. A computer-implemented method for display is disclosed comprising: obtaining a plurality of short-form videos; displaying thumbnails of one or more short-form videos, from the plurality of short-form videos, wherein the displaying thumbnails occurs within a frame on a third-party webpage within a browser window; receiving selection of a video, from the one or more short-form videos, by a user; reducing the video that was selected by a user, wherein the reducing the video enables the video to be rendered in a portion of the browser window; and rendering the video that was reduced, along with a reloaded copy of the third-party webpage, in the browser window. The reducing the video to render the video in a portion of the browser window includes launching a reloaded version of the third-party webpage to render the video superimposed over the third-party webpage. The rendering the video can accomplish a picture-within-picture function. The reducing the video can be accomplished in response to a reduction selection by the user, and the reducing can cause the video to be rendered in a lower right corner of the browser window. The location of the rendering the reduced video can be modified. The video can be maximized, after the reducing, to restore rendering of the video, in the browser window along with the third-party webpage, to an original size of the video. The rendering is accomplished using an updated web address that enables the reducing the video to render the video in a portion of the browser window along with the third-party webpage.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for inline frame-based video rendering within browser.

FIG. 2 illustrates a browser window with a webpage and a frame.

FIG. 3 shows a browser window with a webpage and a larger video.

FIG. 4A illustrates a browser window with a webpage and a reduced video.

FIG. 4B illustrates a browser window with a scrolled webpage and a reduced video.

FIG. 5 shows an example webpage with a frame.

FIG. 6 is a block diagram for a webpage communicating with a source.

FIG. 7 is a system diagram for display.

### DETAILED DESCRIPTION

Techniques for display based on inline frame-based rendering within a browser are disclosed. Webpages can be loaded by an individual using an electronic device such as a desktop computer, a laptop computer, a tablet, a smartphone, a personal digital assistant (PDA), and so on. The webpages that can be loaded using a web browser can include text, images, videos, audio, and other contents that present a message, a feeling or visceral reaction, a theme, an experience, and so on, related to or associated with the webpages. While the information presented at the top level of a given webpage may be useful, access to additional information, “deep dives” or in-depth coverage, and so on, are widely known to greatly enhance the user experience as the individual consumes the webpage content. For example, if an individual is consuming news reports and wishes to learn more about a particular topic, the user can click a link on the page to be provided with further content. The further content can include images, videos, audio, etc. The “clicking” for additional information can include a mouse or trackpad click on an explicit link such as a radio button with text indicating “Click here for more information”. The clicking could further include mousing over an image, selecting an option from a menu, and the like. The “clicking” could also include selecting a short-form video thumbnail presented within a frame on the webpage.

Display is enabled by inline frame-based video rendering within a webpage. A plurality of short-form videos is obtained. The short-form videos can be provided by a content provider, downloaded from a library, uploaded by a user, and so on. A short-form video can include a video that displays for a period of time including a few seconds to a few minutes. Thumbnails of one or more short-form videos, from the plurality of short-form videos, are displayed within a frame on a third-party webpage within a browser window. The frame can be provided by the third-party webpage, incorporated into a window within the web browser, and the like. A user's selection of a video, from the one or more short-form videos, is received. The selection can include a mouse or trackpad click, the movement of a cursor over a short-form video or other content, a menu selection, and so on. The reducing the video to render the video in a portion of the window along with the third-party webpage results in the video being rendered such that it remains fixed in the browser window while the third-party webpage is scrolled. The video that was selected is rendered in the browser window along with the third-party webpage. The rendering of the video can include a maximized video that fits within the browser window, a manipulated size video, and so on. The rendered video can appear at a location within the browser window. The video is reduced to render the video in a portion of the browser window along with a reloaded copy of the third-party webpage.

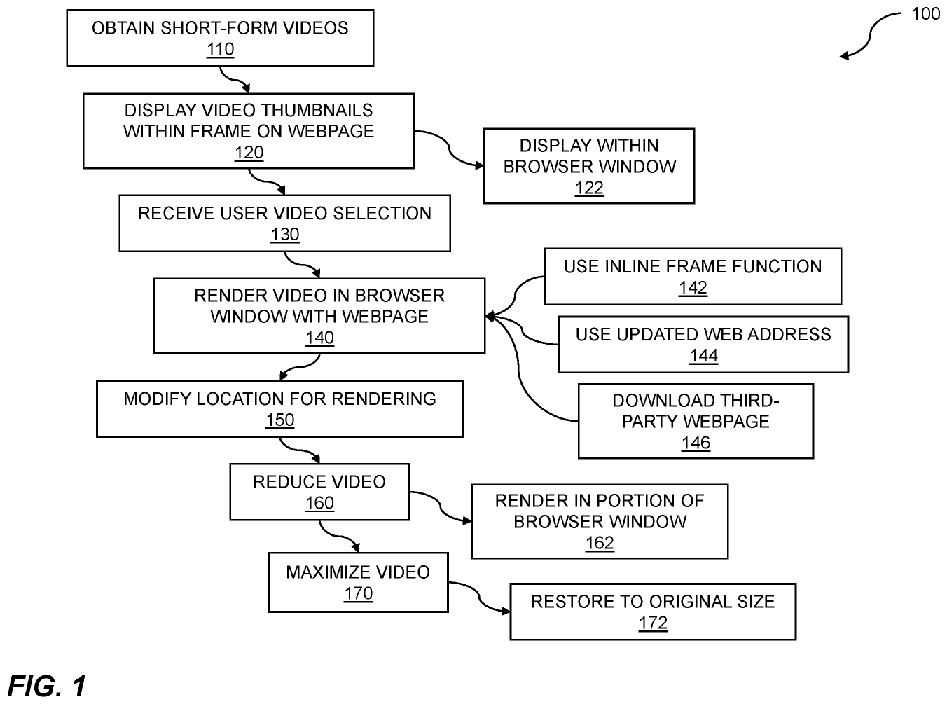

FIG. 1 is a flow diagram for inline frame-based video rendering within a browser. Videos, which can include short-form videos, can include various media types such as news videos, entertainment videos, political message videos, and so on. A short-form video can include a video with a duration of a few seconds, a minute, etc. The videos can be viewed on an electronic device used by an individual. The videos can be included among additional contents of a webpage, where the additional contents can include text, images, and audio. The webpage can include a frame. The short-form videos can be stored on a video server, where the video server is decentralized from the remainder of the webpage content. Short-form videos can be selected from the server and used to populate the frame on the webpage being viewed by the individual. The frame that is populated by the short-form videos can include a horizontal orientation, a vertical orientation, a grid, and the like. The frame can be scrollable in the horizontal orientation, in the vertical orientation, and in the grid configuration. The short-form videos within the frame can be auto played, started and stopped, and the like.

The flow 100 includes obtaining 110 a plurality of short-form videos. The short-form videos can include videos that comprise a variety of subject content. The subject content can include political content, educational content, entertainment content, socially shared content, and so on. The short-form videos can be obtained from a video server, provided by a content provider, downloaded from a video library, uploaded and shared by a user, and the like. The short-form videos can be based on a variety of standards or protocols such as MPEG-4™ Flash™, QuickTime™, etc. The flow 100 includes displaying thumbnails 120 of one or more short-form videos, from the plurality of short-form videos, within a frame. The displaying thumbnails can occur within a frame on a third-party webpage within a browser window. The thumbnails can include a still image from a short-form video, a short graphics interchange format (GIF) of the video, and so on. The thumbnails can be small in comparison to a short-form video with respect to size, resolution, etc. A frame can include a portion of a webpage or a browser window in which content that is independent of the container of the frame can be displayed. The container of the frame can include the webpage, the browser window, etc. Contents of the frame can be loaded independently of the container of the frame. In embodiments, the thumbnails can be dynamic. The dynamic thumbnails can include video segments, GIFs, slideshows, etc. associated with the short-form videos. In embodiments, the thumbnails display active video portions from the one or more short-form videos represented. The active video portions can include a single portion of the video, two or more portions of the video stitched together, etc. In other embodiments, the thumbnails can be updated as further short-form videos are identified for display within the frame on the third-party webpage. In embodiments, the frame is embedded within the third-party webpage. The further short-form videos can be identified by a content provider based on breaking news, world events, sports scores, and the like. The short-form videos can be identified based on user preference, user webpage navigation history, etc. In the flow 100, the thumbnails are displayed on a third-party webpage within a browser window 122. The third-party webpage can be loaded, updated, refreshed, etc., independently of the contents of the frame. The contents of the frame can be updated based on user preferences, browsing history, and the like.

The flow 100 includes receiving selection of a video 130, from the one or more short-form videos, by a user. The selection of a video can be accomplished by checking a box associated with a short-form video, clicking on the short-form video using a mouse or a trackpad, swiping a cursor over a video, selecting a video from a menu of videos, and so on. Selecting the video can highlight the video, can cause a video to start playing within the frame, and the like. The flow 100 includes rendering the video 140 that was reduced, along with a reloaded copy of the third-party webpage, in the browser window. As describe below, the rendering can be of a video that has already been reduced to a reduced-size video. The reduced video can enable the rendering to be displayed in a portion of the third-party webpage, over a blurred-out webpage, in place of the webpage, etc. In the flow 100, the rendering is accomplished using an inline frame function 142 within an Internet browser application. An inline frame function can enable embedding of documents, videos, audio clips, etc., within a webpage. The inline frame function can enable display of a secondary webpage within the main third-party webpage. In embodiments, the inline frame function includes an iFrame (inline frame) operation. An iFrame operation can include an HTML function which enables the display of the secondary webpage within the main page. An iFrame can include a window that can include a content image, text, and the like. The iFrame function can organize navigation of a webpage and selected content. In the flow 100, the rendering is accomplished using an updated web address 144. The updated web address enables reducing the video (discussed shortly) to render the video in a portion of the window along with the third-party webpage. The updated address can include an address of a video server on which the selected short-form video resides, an address on an additional third-party webpage, etc. The flow 100 further includes downloading the third-party webpage 146 for display at the updated web address. The downloading can include downloading the third-party webpage for display in the browser window. The updated address can include the selected video.

In embodiments, the rendering the video can accomplish a picture-within-picture function. The third-party webpage content can be displayed in a window such as a browser window while the short-form video can be rendered in a second window, and where the second window can be rendered within the first window. The picture-within-picture technique enables contemporaneous viewing of a webpage and a video, a video and a video, etc. In embodiments, the third-party webpage includes another video being displayed beyond the video that was selected. In embodiments, the third-party webpage can be an outer picture for the picture-within-picture function. The contents of the third-party webpage not obscured by a short-form video window can be displayed around the short-form video. In other embodiments, the rendering the video such as a short-form video can be an inner picture for the picture-within-picture function. The picture-within-picture technique enables contemporaneous viewing of two or more videos. In embodiments, the rendering the video can accomplish a page-within-page function. In a usage example, the short-form video can be activated by clicking a button to start the video. The requirement to click a button before viewing a video can be used to warn a viewer about age-appropriate, disturbing, or controversial content, and so on.

The flow 100 includes modifying a location 150 for the rendering. The rendering of the short-form video can include rendering the video at a predetermined location within the third-party webpage, at a user-defined location, and so on. The location of the rendering can be modified by the user to enhance viewing of the third-party webpage content, to enable user preference, and the like. A variety of techniques can be used to modify a location of the rendering. In embodiments, the modifying location can be in response to a mouse or trackpad dragging motion by the user, a drag and drop motion, a grid locating selection such as upper left corner or center, and the like.

The flow 100 includes reducing the video 160. The reducing the video can be accomplished by reducing the dimensions of the short-form video, reducing the resolution of the video, and so on. The reducing the video can be accomplished by loading a previously reduced or compressed version of the video. In the flow 100, the reducing enables rendering the video in a portion 162 of the browser window, along with a reloaded copy of the third-party webpage. Discussed above and throughout, the portion of the browser window can include a corner of the browser window; top, left, right, or bottom center of the window; center of the window; and so on. The portion of the window can include a user-selected portion of the window. In embodiments, the reducing can cause the video to render in a lower right corner of the browser window. In further embodiments, the reducing the video to render the video in a portion of the browser window comprises launching a reloaded version of the third-party webpage to render the video superimposed over the third-party webpage. The launching the reloaded version of the webpage can include opening a new browser window or a new browser tab, reusing a browser window, etc. In embodiments, the reducing the video can be accomplished in response to a reduction selection by the user. The user can click a button, make a menu selection, double click the video, right click the video, etc. In other embodiments, the rendering the video and the reducing the video can be accomplished without a popup window.

The short-form video that is rendered prior to reducing can fill a browser window, can be scaled up or scaled down to fit the window, can be smaller than the window, and so on. In embodiments, the portion of the browser window can be smaller than the rendering of the video before the reducing. In other embodiments, the reducing the video to render the video, in a portion of the window along with the third-party webpage, can result in the video being rendered such that it remains fixed in the browser window while the third-party webpage is scrolled. The rendered reduced video can continue to play while the third-party webpage is scrolled up or down, while button clicks are performed on the third-party page, and the like. The flow 100 further includes maximizing 170 the video after the reducing. The maximizing can include filling a browser window with the short-form video, up-scaling or down-scaling the video to fit the window, and so on. The maximizing the video can be accomplished by selecting an appropriately sized video for rendering. In the flow 100, the video is maximized to restore rendering 172 of the video, in the browser window along with the third-party webpage, to an original size of the video. The restoring can include displaying the restored video over the third-party webpage, over a blurred version of the third-party webpage, etc. Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

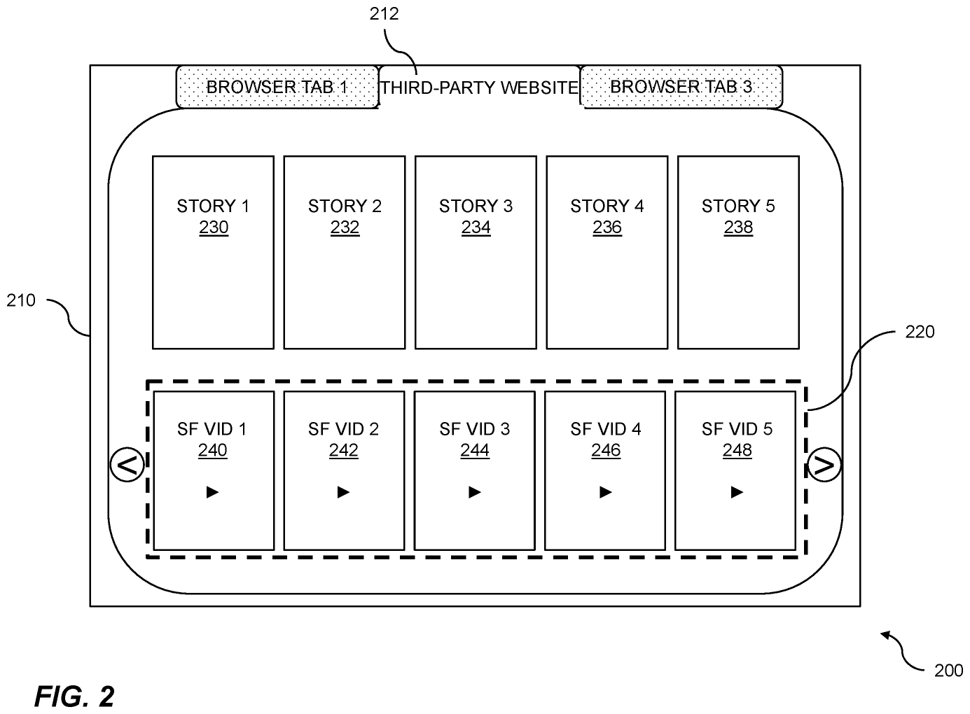

FIG. 2 illustrates a browser window with a webpage and frame. A user can open a web browser on an electronic device and can connect or “surf” to a website. The web browser can include a popular web browsing application or app, such as Edge™, Safari™ Chrome™ Firefox™, Opera™, Lycos™, and so on. The electronic device can include a computer, a smartphone, a tablet, a PDA, a set-top box, a gaming console, and the like. To connect to a website, the user enters a web address, also referred to as a uniform resource locator (URL), for the website. The landing or home page at the web address opens within a window of the web browser. The webpage that is opened can include a frame. The frame can display content that can be presented and accessed independently of the webpage that contains the frame. The webpage that contains the frame can also be called the container. The frame within the webpage supports inline frame-based video rendering with a browser. A plurality of short-form videos is obtained. Thumbnails of one or more short-form videos, from the plurality of short-form videos, are displayed within a frame on a third-party webpage within a browser window. A user's selection of a video, from the one or more short-form videos, is received. The video that was selected is rendered in the browser window along with the third-party webpage. The video is reduced to render the video in a portion of the browser window, along with a reloaded copy of the third-party webpage.

A browser window with a webpage and frame is shown 200. A browser window 210 can be used to display content located at a third-party web address on a browser tab 212. The browser window can include a standalone browser window, a tab which can represent one or more open windows within a web browser, and so on. The webpage content can include text, images, audio, videos, and so on. The browser window tab 212 can display one or more stories, articles, features, items, etc., such as story 1 230, story 2 232, story 3 234, story 4 236, and story 5 238. Only one story or many stories may be displayed. The browser window can include a frame 220. The frame can be used to present content that can be substantially similar to the content of the webpage or can be substantially dissimilar to the webpage. The frame can include text, images, audio, video, etc. The content within the frame can be based on top stories, user preferences, user browsing history, and so on. The frame 220 can include one or more short-form videos such as short-form video 1 240, short-form video 2 242, short-form video 3 244, short-form video 4 246, and short-form video 5 248. The short-form video or videos can be related to the stories included on browser window tab 212. The user can select an object presented within the frame by clicking on the item, moving a cursor over the item, selecting the item from a menu, etc.

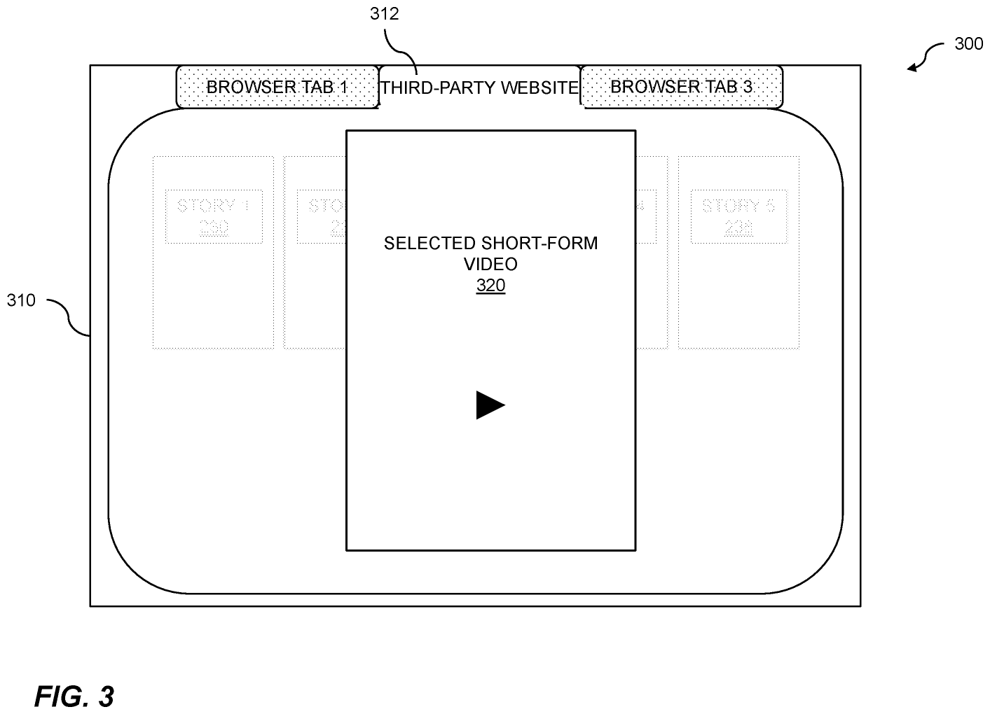

FIG. 3 shows a browser window with a webpage and a larger video. Discussed previously and throughout, a user can select an object within a frame. The frame can be associated with a webpage, a browser, a window, and so on. The selected object within the frame can “open” to present text, images, audio, video, and so on. The video can open as a larger video within a browser window, a browser tab, etc. Display of a larger video and a webpage enables inline frame-based video rendering within a browser. Short-form videos are obtained, and thumbnails of the short-form videos are displayed within a frame on a third-party webpage within a browser window. A video selection by a user is received, and the selected video is rendered in the browser window along with the third-party webpage. The video is reduced to render the video in a portion of the browser window along with a reloaded copy of the third-party webpage.

A browser window that contains a webpage and a larger video is shown 300. The browser window 310 can include a window of a popular or favorite browser, a tab associated with a browser window, and so on. The webpage displayed within the browser window can be associated with a web address 312. A short-form video that was selected can be rendered as a large, selected short-form video 320. The rendering of the large video can enable auto-playing of the video; manual starting, pausing, or stopping of the video; and so on. The large video can be displayed over the third-party webpage such that visible portions of the third-party webpage beyond the boundaries of the large video can be displayed. The displaying the third-party webpage can include a clear view of the visible portions of the webpage, a blurred view of the webpage, a blacked out or whited out view, and so on.

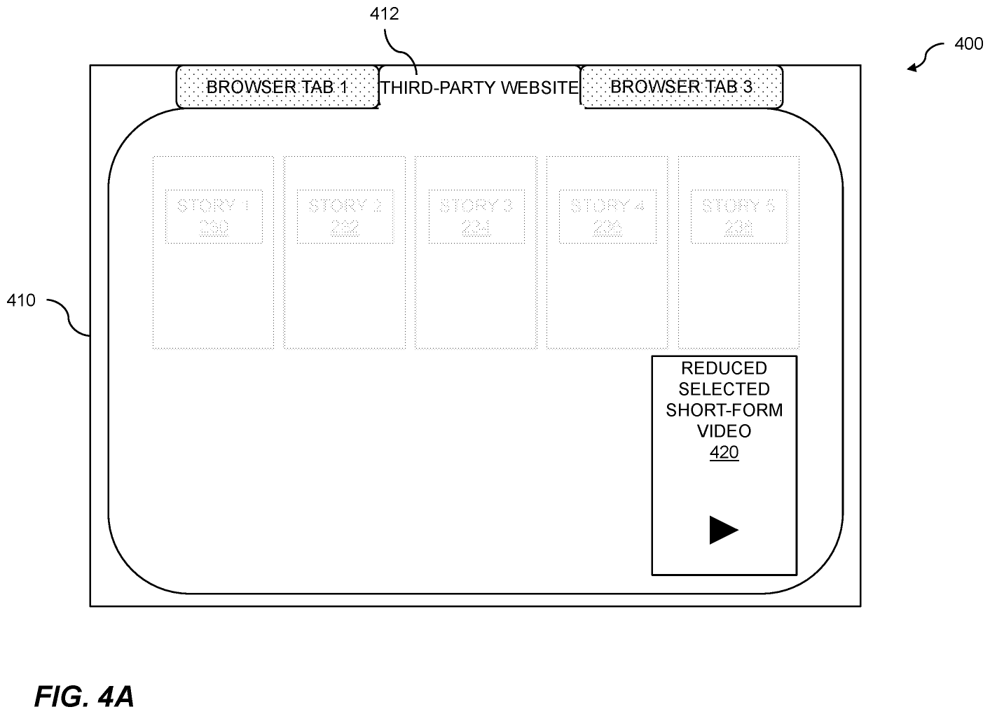

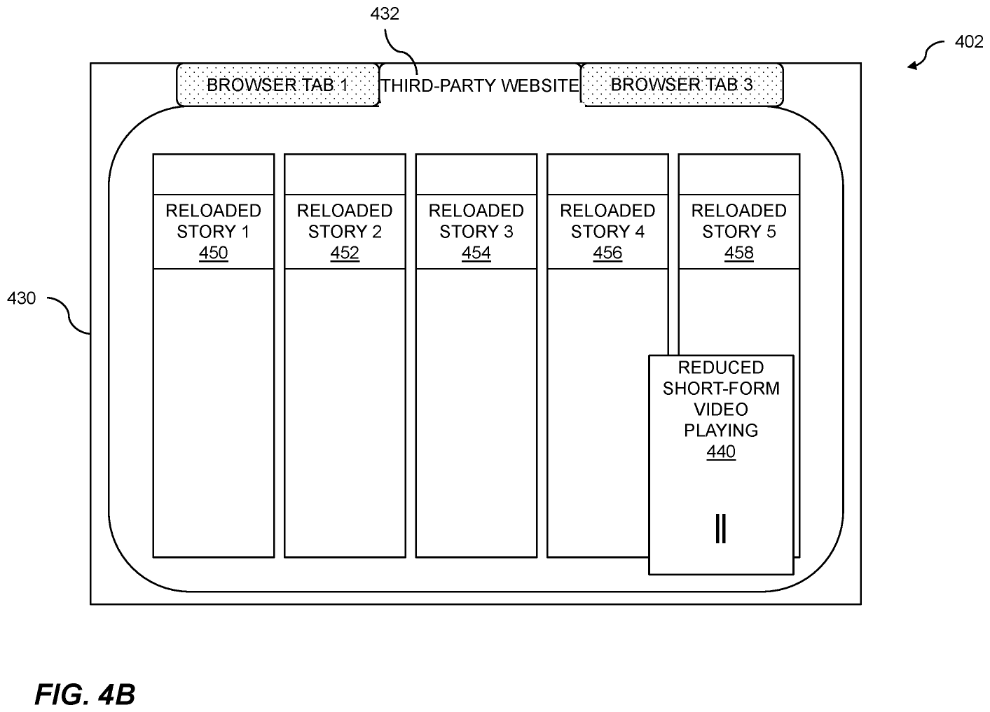

FIG. 4A illustrates a browser window with a webpage and a reduced video. Thumbnails associated with one or more videos such as a short-form videos can be displayed within a frame associated with a webpage or web browser. A user can select a video for rendering within a browser window. The video can be reduced so that the video can be rendered in a portion of the browser window along with a reloaded copy of a third-party webpage. In embodiments, the reducing the video to render the video in a portion of the browser window can include launching a reloaded version of the third-party webpage to render the video superimposed over the third-party webpage. Rendering the video in a portion of the browser window supports inline frame-based video rendering within a browser. A plurality of short-form videos is obtained. Thumbnails of one or more short-form videos, from the plurality of short-form videos, are displayed within a frame on a third-party webpage within a browser window. A user's selection of a video, from the one or more short-form videos, is received. The video that was selected is rendered in the browser window along with the third-party webpage. The video is reduced to render the video in a portion of the browser window along with a reloaded copy of the third-party webpage.

A browser window, within which are rendered a third-party webpage and a reduced video, is shown 400. The browser window 410 can be associated with a web browser that can be selected and executed by a user. A web address 412 can be associated with the rendered third-party website. A reduced short-form video 420 can be included within the browser window or tab. The reduced window can be rendered at various locations within the browser window. In embodiments, the reducing can cause the video to be rendered in a lower right corner of the browser window. The location of the reduced video can be fixed, predefined, user defined, and so on. Embodiments can include modifying a location for the rendering. The modifying can include clicking on a grid, choosing a menu option, and the like. In embodiments, the modifying location can be in response to a mouse or trackpad dragging motion by the user.

FIG. 4B illustrates a browser window with a scrolled webpage and a reduced video 402. Described previously, a third-party webpage and a reduced video can be rendered within a browser window or tab associated with a web browser. The reduced video can be located at a user selectable location within the browser window, at a predefined location, and so on. In embodiments, the reducing the video can cause the video to render in a lower right corner of the browser window. Irrespective of the location of the reduced video within the browser window or a tab, the third-party webpage can be scrolled while the reduced video remains in place. Scrolling the third-party webpage supports inline frame-based video rendering within a browser.

A browser window 430 is shown in which a third-party webpage and a reduced video are rendered. The reduced short-form video 440 can be rendered at a location within the browser window. The location of the video within the browser window can include a corner, the center, and so on. The third-party webpage can be scrolled to enable viewing of content of the third-party webpage. In embodiments, the reducing the video to render the video, in a portion of the window along with the third-party webpage, can result in the video being rendered such that it remains fixed in the browser window while the third-party webpage is scrolled. The reduced video can play while the third-party website is scrolled. Content presented on the third-party website can be selected for viewing, watching, listening, reading, and so on. In embodiments, the rendering the video can accomplish a picture-within-picture function. The reduced video can be accompanied with one or more options to select further content. The further content can include videos, images, text, audio, and so on. The further content can comprise a webpage. The further content can be rendered. In embodiments, the rendering the video can accomplish a page-within-page function. The reduced short-form video 440 that is playing can be displayed on a reloaded third-party website page 432, which displays a reloaded set of stories, articles, features, items, etc., such as reloaded story 1 450, reloaded story 2 452, reloaded story 3 454, reloaded story 4 456, and reloaded story 5 458. The reloaded stories on the third-party webpage can be the same or different from previously loaded stories. In any case, the reduced short-form video is playing over a portion of reloaded third-party website page 432.

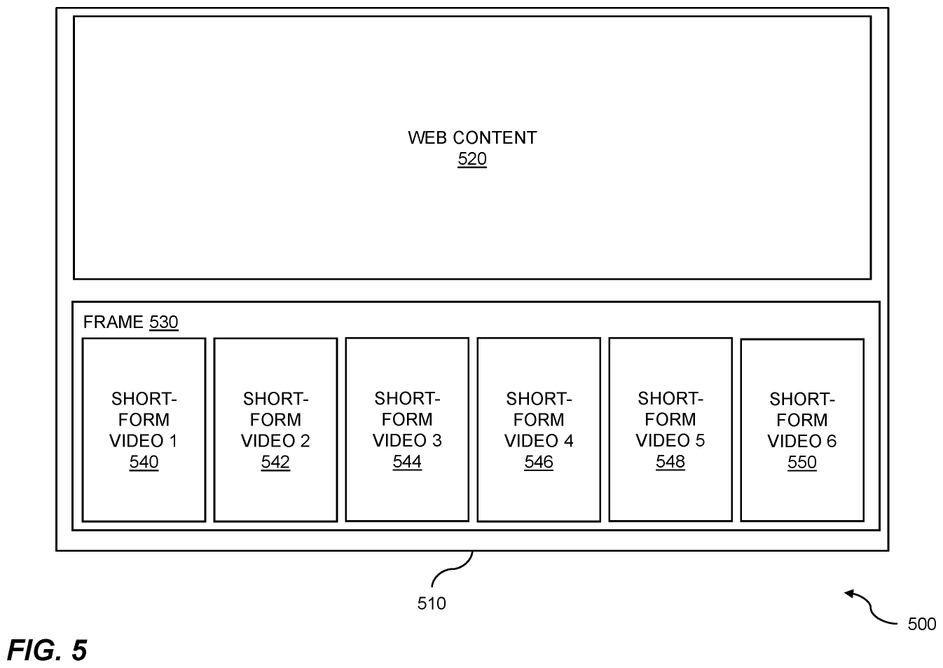

FIG. 5 is an example webpage with a frame. A webpage that includes a frame can be rendered on a display. The frame can be populated with short-form videos which have been selected based on analysis of textual information analyzed within the webpage. The contents of the frame can be selected based on machine learned curating of videos for selection and display. A user can select a video from among the one or more short-form videos. A webpage with a frame supports inline frame-based video rendering within a browser. A plurality of short-form videos is obtained. Thumbnails of one or more short-form videos, from the plurality of short-form videos, within a frame on a third-party webpage within a browser window, are displayed. A user's selection of a video, from the one or more short-form videos, is received. The video that was selected is rendered in the browser window, along with the third-party webpage. The video is reduced to render the video in a portion of the browser window along with a reloaded copy of the third-party webpage. The reducing the video to render the video in a portion of the browser window comprises launching a reloaded version of the third-party webpage to render the video superimposed over the third-party webpage.

An example webpage with a frame is shown 500. The webpage and frame can be rendered on a display 510, where the display can include a display associated with a computing device such as a laptop computer or desktop computer; a personal electronic device such as a tablet, smartphone, or PDA; and so on. The webpage can include web content 520. The web content can include text, images, video clips, videos, audio, audio clips, and so on. Discussed throughout, the webpage content is analyzed for textual information, video information, audio information, etc. A plurality of short-form videos is selected based on analysis of the information gleaned from the webpage. The selected short-form videos can be used to populate a frame 530 included in the webpage content. The short-form videos can include short-form video 1 540, short-form video 2 542, short-form video 3 544, short-form video 4 546, short-form video 5 548, and short-form video 6 550. While six short-form videos are shown, other numbers of short-form videos can populate the frame on the webpage.

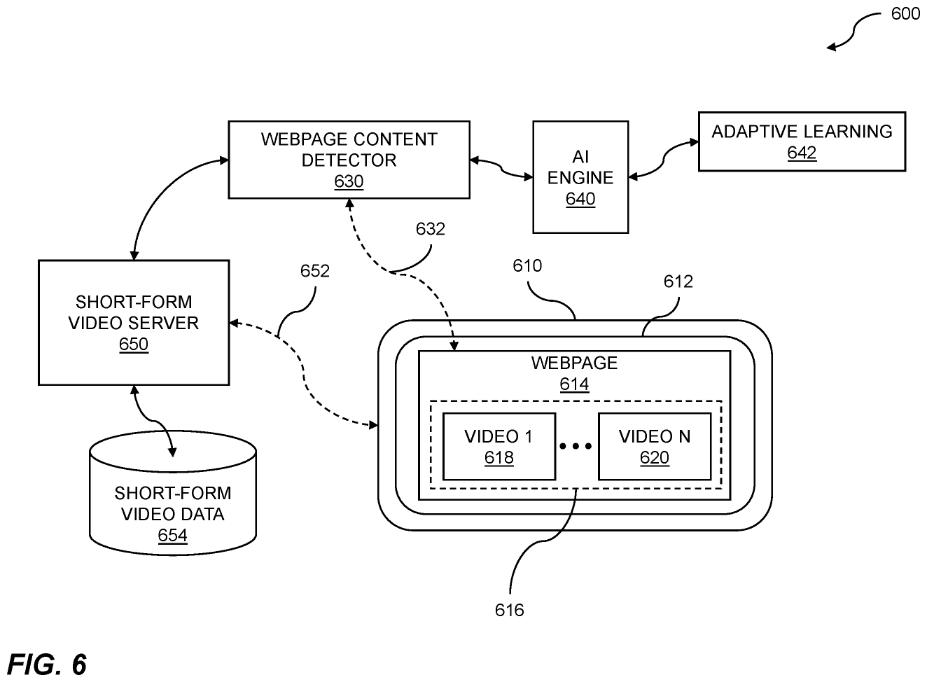

FIG. 6 is a block diagram 600 for a webpage communicating with a source. The communication between the webpage and the source enables inline frame-based video rendering within a browser. A plurality of short-form videos is obtained. Thumbnails of one or more short-form videos, from the plurality of short-form videos, within a frame on a third-party webpage within a browser window, are displayed. A user's selection of a video, from the one or more short-form videos, is received. The video that was selected is rendered in the browser window, along with the third-party webpage. The video is reduced to render the video in a portion of the browser window along with a reloaded copy of the third-party webpage.

Described throughout, short-form videos can be selected from a plurality of short-form videos hosted by a short-form video server. The selecting can be based on a webpage visited by a user. The webpage can include one of a plurality of webpages that can be viewed by the user. Based on analysis of the webpage, short-form videos are selected from the server and displayed on the webpage viewed by a user. The user can visit a webpage using an electronic device 610. The electronic device can include a desktop or laptop computer, a tablet or smartphone, a personal digital assistant (PDA), and so on. The electronic device is coupled to a display 612 on which a webpage 614 can be rendered. A frame 616 on the webpage is populated with videos such as video 1 618, video N 620, and so on. While two videos are shown, other numbers of videos can be populated within the frame. The electronic device can be in communication with a webpage content detector 630. The communication between the electronic device and the webpage content detector can be accomplished using a communication channel such as a wireless communication channel 632. The webpage content detector can analyze the webpage for textual information. The textual information can be detected by searching for text on the webpage. In addition, webpage tags, hidden text, and so on can augment the textual information. The textual information can be detected based on natural language analysis of audio data from the webpage. The webpage content detector can be controlled by an artificial intelligence (AI) engine 640. The AI engine, which can be based on a neural network, such as a convolutional neural network or a recurrent neural network, can be used to curate selection of one or more short-form videos. The short-form videos that are selected can be used to populate the frame 616 within the webpage 614. The AI engine 640 can include adaptive learning 642. Adaptive learning, described presently, can be embedded in the AI engine 640 or can be implemented in a distributed fashion.

The webpage content detector 630 can access a short-form video server 650. The short-form video server can be decentralized from other compute and storage capabilities related to the webpage. The short-form video server can be in communication with the electronic device via a communication channel 652, where the communication channel can include a wireless communication channel. The short-form video server can provide a plurality of short-form videos. The short-form videos can be selected from short-form video data storage 654. The short-form video data storage can include decentralized storage. The short-form videos selected by the short-form video server can be used to populate the frame 616 on the electronic device 610. Representations of the short-form videos can be displayed within the frame on the webpage, where the displaying can include auto playing the short-form videos.

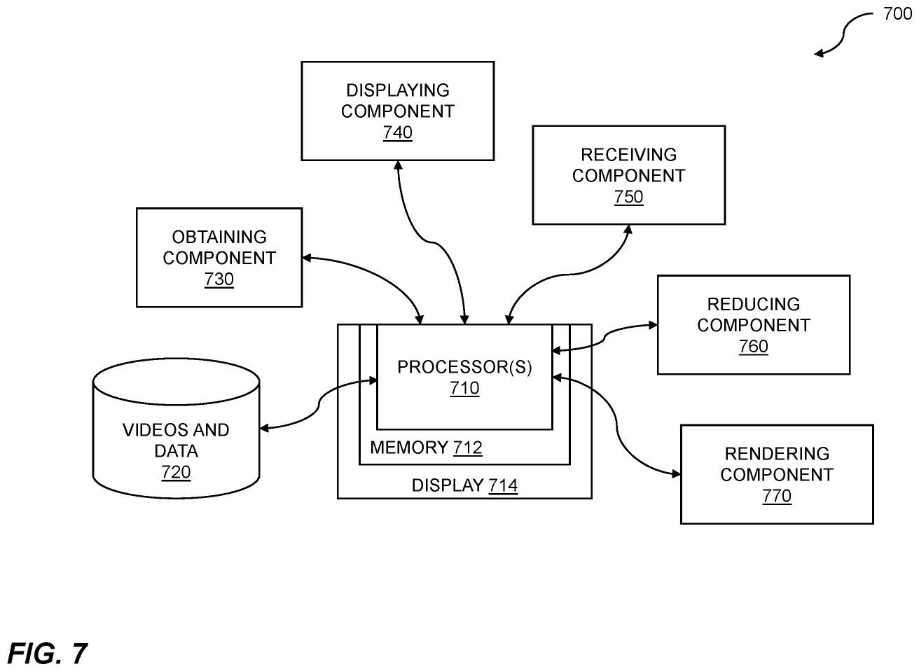

FIG. 7 is a system diagram for display. Display is based on inline frame-based video rendering within a browser. The system 700 can include one or more processors 710 attached to a memory 712 which stores instructions. The system 700 can include a display 714 coupled to the one or more processors 710 for displaying data, videos, short-form videos, intermediate steps, instructions, and so on. In embodiments, one or more processors 710 are attached to the memory 712 where the one or more processors, when executing the instructions which are stored, are configured to: obtain a plurality of short-form videos; display thumbnails of one or more short-form videos, from the plurality of short-form videos, wherein the displaying thumbnails occurs within a frame on a third-party webpage within a browser window; receive selection of a video, from the one or more short-form videos, by a user; reduce the video that was selected by a user, wherein the reducing the video enables the video to be rendered in a portion of the browser window; and render the video that was reduced, along with a reloaded copy of the third-party webpage, in the browser window.

The system 700 can include a collection of videos and data 720. The videos and data 720 may be stored in storage such as electronic storage coupled to the one or more processors, a database, one or more statically linked libraries, one or more dynamically linked libraries, or other appropriate video or data formats. The videos can include short-form videos. A short-form video can include a video that can be shown with an amount of time including a few seconds, several seconds, a minute, and so on. A short-form video can convey content quickly and efficiently to a viewer of the short-form video. The short-form video can present a story, an advertisement, a political message, and the like. A short-form video can include a video from among a plurality of videos, where the videos can comprise a wide range or variety of content. The data can include textual information or data that can be associated with a webpage, as discussed below. The textual information can be augmented with image information, themes, and so on. The system 700 can include an obtaining component 730. The obtaining component 730 can include functions and instructions for obtaining a plurality of short-form videos. The short-form videos can include content such as news, sports, advertisements, political ads, culture, popular news such as celebrity updates, cute puppy and kitten videos, and so on. The short-form videos can include curated videos, videos downloaded from a library or short-form video server, social media or other shared videos, videos uploaded by one or more users, and the like. The short-form videos obtainable through the short-form video server can include videos in a variety of video formats such as MPEG-4™, Flash™ QuickTime™, etc. The short-form video server can include a local server, a cloud-based server, a mesh server, and so on. The short-form videos accessible through the video server can include advertising videos, social videos, news and information videos, political message videos, and so on.

The system 700 can include a displaying component 740. The displaying component 740 can include functions and instructions for displaying thumbnails of one or more short-form videos, from the plurality of short-form videos, within a frame on a third-party webpage within a browser window. The thumbnails can be associated with the short-form videos, obtained with the short-form videos, generated for the short-form videos based on reducing the dimensions of the short-form videos, etc. The thumbnails can include an auto-play technique, a looping GIF, an animation, and the like. The frame can include a frame within a third-party webpage. The frame can be used to display a plurality of short-form videos. In embodiments, the frame can be added to an existing webpage. The browser window can include a window associated with any of a variety of web browsers available on platforms including computers such as laptop and desktop computers; personal electronic devices such as smartphones, tablets, and PDAs; and the like. The browser window can include a standalone window, a tab within a browser window, etc. The browser window can display the third-party webpage, the video thumbnails within the frame, and the like.

The system 700 can include a receiving component 750. The receiving component 750 can include functions and instructions for receiving selection of a video, from the one or more short-form videos, by a user. The response can include a user-initiated response such as clicking a button, clicking on a short-form video thumbnail, selecting a menu option, and so on. Embodiments can include receiving a response to a call to action embedded within the frame on the webpage. A call to action can include “click here”, “sign up now”, “buy now”, etc. The call to action can include registration, a financial activity, a political action, and the like.

The system 700 can include a reducing component 760. The reducing component 760 can include functions and instructions for reducing the video to render the video in a portion of the browser window along with a reloaded copy of the third-party webpage. In embodiments, the reducing the video to render the video in a portion of the browser window can include launching a reloaded version of the third-party webpage to render the video superimposed over the third-party webpage. The reloading the third-party webpage can be accomplished without user action or intervention. The reduced video can be displayed at various positions within the third-party webpage. In embodiments, the reducing can cause the video to be rendered in a lower right corner of the browser window. Other locations within the browser window can be modified. In embodiments, the modifying location can be in response to a mouse dragging motion by the user. The reducing of the video can be accomplished by clicking on the video, moving a cursor away from the video, and the like. In embodiments, the reducing the video is in response to a reduction selection by the user. The user selection can include a button click, a menu selection, and so on. In other embodiments, the reducing the video to render the video, in a portion of the window along with the third-party webpage, can result in the video being rendered such that it remains fixed in the browser window while the third-party webpage is scrolled. The video can continue to play while the webpage is scrolled, read, viewed, etc. Embodiments can include maximizing the video, after the reducing, to restore rendering of the video, in the browser window along with the third-party webpage, to an original size of the video. In other embodiments, the rendering the video and the reducing the video can be accomplished without a popup window.

The system 700 can include a rendering component 770. The rendering component 770 can include functions and instructions for rendering the video that was selected in the browser window along with the third-party webpage. The rendering can include displaying the video at full resolution, at a resolution that can be adjusted to fit the window, and so on. In embodiments, the video can be rendered in “on top” of the third-party webpage, where the third-party webpage can be clearly visible outside of the video, blurred outside of the video, etc.

An automatic curating of the plurality of short-form video can be accomplished by selecting short-form videos. The selecting the short-form videos can be based on a “script”, a predetermined policy, an advertising campaign, a political message, and the like. In embodiments, the automatic curating comprises selecting, by a neural network, a subset of the plurality of short-form videos that are appropriate for the webpage. The neural network can be used to infer an appropriate selection of short-form videos, to predict an appropriate selection, and the like. The neural network can include a convolutional neural network, a recurrent neural network, etc. In embodiments, the automatic curating includes machine learning. The machine learning can include training the neural network with a training dataset, where the training dataset includes known good data and expected outcomes based on the data. The machine learning can include deep learning, and can be based on unsupervised learning, supervised learning, etc. In other embodiments, the automatic curating can provide the subset based on contextual information from the webpage. The contextual information from the website can include the type of website such as a news website, an entertainment website, an e-commerce website, and the like. In embodiments, the contextual information can be based on natural language processing for audio information from the webpage. The audio information can be audio information provided when a user first visits the website, audio information that results from the user navigating the website based on menu selections or button clicks, etc. In further embodiments, the contextual information can be based on video information from the webpage. The video information can be provided by the website, selected by the user, and so on. In other embodiments, the automatic curating can be based on a long short-term memory model which tracks recent behavior by a user accessing the webpage. A long short-term memory model can be implemented on a recurrent neural network. A long short-term memory model can process single data points such as one or more images, sequences of data such as audio or video, etc. In embodiments, the curating uses temporally weighted behaviors by a user accessing the webpage. The temporally weighted behaviors can include an amount of time spent on a webpage, video, audio, etc. The temporally weighted behaviors can be based on a frequency of button clicks or menu selections, an amount of time which has elapsed between button clicks or menu selections, and so on.

The system 700 can include a computer program product embodied in a non-transitory computer readable medium for display, the computer program product comprising code which causes one or more processors to perform operations of: obtaining a plurality of short-form videos; displaying thumbnails of one or more short-form videos, from the plurality of short-form videos, wherein the displaying thumbnails occurs within a frame on a third-party webpage within a browser window; receiving selection of a video, from the one or more short-form videos, by a user; reducing the video that was selected by a user, wherein the reducing the video enables the video to render in a portion of the browser window; and rendering the video that was reduced, along with a reloaded copy of the third-party webpage, in the browser window.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”— may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for display comprising:
obtaining a plurality of short-form videos;
displaying thumbnails of one or more short-form videos, from the plurality of short-form videos, wherein the displaying thumbnails occurs within a frame on a third-party webpage within a browser window;
receiving selection of a video, from the one or more short-form videos, by a user;
reducing the video that was selected by a user, wherein the reducing the video enables the video to render in a portion of the browser window; and
rendering the video that was reduced, along with a reloaded copy of the third-party webpage, in the browser window.

2. The method of claim 1 wherein the reducing the video to render the video in a portion of the browser window comprises launching a reloaded version of the third-party webpage to render the video superimposed over the third-party webpage.

3. The method of claim 1 wherein the reducing the video is in response to a reduction selection by the user.

4. The method of claim 1 wherein the reducing causes the video to be rendered in a lower right corner of the browser window.

5. The method of claim 1 further comprising modifying location for the rendering.

6. The method of claim 5 wherein the modifying location is in response to a mouse dragging motion by the user.

7. The method of claim 1 wherein the portion of the browser window is smaller than the rendering of the video before the reducing.

8. The method of claim 1 wherein the reducing the video to render the video, in a portion of the browser window along with the third-party webpage, results in the video being rendered such that it remains fixed in the browser window while the third-party webpage is scrolled.

9. The method of claim 1 further comprising maximizing the video, after the reducing, to restore rendering of the video, in the browser window along with the third-party webpage, to an original size of the video.

10. The method of claim 1 wherein the rendering the video accomplishes a picture-within-picture function.

11. The method of claim 10 wherein the third-party webpage is an outer picture for the picture-within-picture function.

12. The method of claim 11 wherein the rendering the video is an inner picture for the picture-within-picture function.

13. The method of claim 12 wherein the third-party webpage includes another video being displayed beyond the video that was selected.

14. The method of claim 1 wherein the rendering the video accomplishes a page-within-page function.

15. The method of claim 1 wherein the frame is embedded within the third-party webpage.

16. The method of claim 1 wherein the rendering the video and the reducing the video is accomplished without a popup window.

17. The method of claim 1 wherein the rendering is accomplished using an inline frame function within an Internet browser application.

18. The method of claim 17 wherein the inline frame function includes an inline frame (iFrame) operation.

19. The method of claim 1 wherein the rendering is accomplished using an updated web address that enables the reducing the video to render the video in a portion of the browser window along with the third-party webpage.

20. The method of claim 19 further comprising downloading the third-party webpage for display at the updated web address.

21. The method of claim 1 wherein the thumbnails are dynamic.

22. The method of claim 21 wherein the thumbnails display active video portions from the one or more short-form videos represented.

23. The method of claim 21 wherein the thumbnails are updated as further short-form videos are identified for display within the frame on the third-party webpage.

24. A computer program product embodied in a non-transitory computer readable medium for display, the computer program product comprising code which causes one or more processors to perform operations of:
obtaining a plurality of short-form videos;
displaying thumbnails of one or more short-form videos, from the plurality of short-form videos, wherein the displaying thumbnails occurs within a frame on a third-party webpage within a browser window;
receiving selection of a video, from the one or more short-form videos, by a user;
reducing the video that was selected by a user, wherein the reducing the video enables the video to render in a portion of the browser window; and
rendering the video that was reduced, along with a reloaded copy of the third-party webpage, in the browser window.

25. A computer system for display comprising:
a memory which stores instructions;
one or more processors attached to the memory wherein the one or more processors, when executing the instructions which are stored, are configured to:
obtain a plurality of short-form videos;
display thumbnails of one or more short-form videos, from the plurality of short-form videos, wherein the displaying thumbnails occurs within a frame on a third-party webpage within a browser window;
receive selection of a video, from the one or more short-form videos, by a user;
reduce the video that was selected by a user, wherein the reducing the video enables the video to render in a portion of the browser window; and
render the video that was reduced, along with a reloaded copy of the third-party webpage, in the browser window.
